(19) United States
(12) Patent Application Publication
(10) Pub. No.: US 2011/0120279 A1
(43) Pub. Date: May 26, 2011

(54) Manual Food Dicer

(76) Inventor: Ori BRAUN, Palo Alto, CA (US)

(21) Appl. No.: 12/626,657

(22) Filed: Nov. 26, 2009

(51) Int. Cl. B26D 1/00; A47J 43/04; B26D 7/00; B26D 5/08

(52) U.S. Cl. 83/13; 99/538; 83/167; 83/613

(57) ABSTRACT

A manually operated food dicer having a frame structure which is supported above a support surface, the frame structure having a top surface that includes at least a first slicing blade and at least one carriage guide configuration. A food item carriage displaceably deployed on the frame structure by way of the carriage guide configuration, the food item carriage including an upper receptacle for receiving food items and a lower dicing blade platform. As the food item carriage traverses the length of the frame structure in a cutting direction, the upper receptacle passes over the slicing blade resulting in a slide of the food item being deposited on the lower dicing blade platform, after which the carriage guide configuration brings a top surface of the lower dicing blade platform into contact with a bottom dicing surface of the frame structure further cutting the food item slice into diced food cubes.

### FIELD AND BACKGROUND OF THE INVENTION

The present invention relates to manually operated devices for slicing and dicing food stuffs and, in particular, it concerns a manually operated device that dices food items in a single sliding action.

Manual food slicing devices, such at that disclosed in U.S. Pat. No. 7,107,890, have been known for many years. However, manual devices whose end result leaves the food item in a diced state have only recently been introduced.

An example of such a device for dicing food items is disclosed in U.S. Patent Application No. 2009/0133587, which is directed toward an improvement of U.S. Pat. No. 7,107,890. 2009/0133587 relates to a mechanism for retracting cutting blades below the cutting surface of the device during the return movement of the food carriage.

The dicer of US2009/0123623 includes a displaceable cutting surface that reciprocates between upper and lower positions. To achieve diced food items, it is necessary to move the food item across the length of the cutting surface in one direction, rotate the food holder together with the food item 90° and then move the food item across the length of the cutting surface again in the other direction.

There is therefore a need for a simplified manually operated device that produces diced food items in a single sliding action.

### SUMMARY OF THE INVENTION

The present invention is a manually operated device that dices food items in a single sliding action.

According to the teachings of the present invention there is provided, a manually operated food dicer comprising: (a) a frame structure which is supported above a support surface, the frame structure having a top surface that includes at least a first slicing blade the frame structure including at least one carriage guide configuration; (b) a food item carriage displaceably deployed on the frame structure by way of the carriage guide configuration, the food item carriage including an upper receptacle for receiving food items and a lower dicing blade platform; wherein as the food item carriage traverses a length of the frame structure in a cutting direction, the upper receptacle passes over the slicing blade, after which the carriage guide configuration brings a top surface of the lower dicing blade platform into contact with a bottom dicing surface of the frame structure.

According to a further teaching of the present invention, the carriage guide configuration includes corresponding longitudinal slots configured on opposite longitudinal sides of the frame structure and the food item carriage is configured to engage the corresponding longitudinal slots.

According to a further teaching of the present invention, the corresponding longitudinal slots are configured as four corresponding longitudinal slots with two the longitudinal slots configured on each of the opposite sides of the frame structure.

According to a further teaching of the present invention, the corresponding longitudinal slots are configured to guide the dicing blade platform into the contact with the bottom dicing surface of the frame structure.

According to a further teaching of the present invention, the engagement of the food item carriage with the corresponding longitudinal slots includes engagement of at least one connecting element by which the upper receptacle and the lower dicing blade platform are connected.

According to a further teaching of the present invention, the dicing blade platform includes blades arranged in a grid configuration.

According to a further teaching of the present invention, bottom dicing surface of the frame structure includes grooves arranged in a grid configuration corresponding to the grid configuration of the dicing blade platform.

According to a further teaching of the present invention, bottom dicing surface of the frame structure includes raised areas between the grooves so as to push food item cubes from the dicing blade platform.

According to a further teaching of the present invention, there is also provided strip cutting blades associated with the slicing blade.

According to a further teaching of the present invention, the dicing blade platform includes blades arranged perpendicular to a length of the frame structure.

There is also provided according to the teachings of the present invention, a method for dicing food items, the method comprising: (a) cutting the food item using at least a slicing blade deployed relative to a top surface of a frame structure; (b) depositing resulting cut food item on a top surface of a dicing blade platform; (c) bring the top surface of the dicing blade platform into contact with a dicing surface configured in a bottom surface of the frame structure, thereby forcing the cut food item through the dicing blade platform.

According to a further teaching of the present invention, steps a, b and c are performed during a single pass as the food item carriage traverses a length of the frame structure in a cutting direction.

According to a further teaching of the present invention, steps a, b and c are performed during a single pass as the food item carriage traverses a length of the frame structure in a first direction and then repeated as the food item carriage traverses a length of the frame structure in a second direction.

According to a further teaching of the present invention, wherein the forcing the cut food item through the dicing blade platform is implemented using raised areas provided in the dicing surface.

### BRIEF DESCRIPTION OF THE DRAWINGS

The invention is herein described, by way of example only, with reference to the accompanying drawings, which are schematic in nature and intended to provided detail necessary for one of ordinary skill in the art to understand the basic operation of the invention, wherein:

FIG. 1 is a schematic isometric view of a first preferred embodiment of a dicer constructed and operational according to the teachings of the present invention, shown at the beginning of the cutting stroke;

FIG. 2 is a schematic view of the embodiment of FIG. 1, shown after the food item is sliced;

FIG. 3 is a schematic view of the embodiment of FIG. 1, shown at the end of the cutting stroke, after the food item is diced;

FIGS. 4 and 4C-4D are schematic top views of variations of a dicing blade platform constructed and operational according to the teachings of the present invention;

FIGS. 4A and 4B are schematic isometric details of variations of the dicing blades of the dicing blade platform of FIG. 4;

FIG. 5 is a schematic view of the underside of the embodiment of FIG. 1 showing bottom dicing surface of the frame structure configured with grooves that correspond to the blades of the dicing blade platform;

FIG. 5A is a schematic isometric detail of the bottom dicing surface of FIG. 5;

FIGS. 6A-7B are schematic isometric details showing the interaction of the dicing blade platform and the bottom dicing surface of the frame structure with regard to variations of the carriage guide configuration;

FIG. 8 is a schematic view of a second preferred embodiment of a dicer constructed and operational according to the teachings of the present invention, in which movement of the food item carriage in either direction constitutes a cutting stroke;

FIG. 9 is a schematic view of a third preferred embodiment of a dicer constructed and operational according to the teachings of the present invention, having an alternative slicing blade and carriage guide configuration, shown at the beginning of the cutting stroke;

FIG. 10 is a schematic view of a fourth preferred embodiment of a dicer constructed and operational according to the teachings of the present invention, having an alternative slicing blade configuration, shown at the beginning of the cutting stroke.

FIG. 11 is an isometric side top view of a third preferred embodiment of a dicer constructed and operational according to the teachings of the present invention;

FIG. 12 is an isometric side top view of the embodiment of FIG. 11 in which some components of the food item carriage are removed so as to better reveal the longitudinal slots;

FIG. 13 is an isometric side bottom view of the embodiment of FIG. 11 in which some components of the food item carriage are removed so as to better reveal the bottom dicing surface;

FIG. 14 is an isometric bottom view of the embodiment of FIG. 11; and

FIG. 15 is an isometric end view of the embodiment of FIG. 11.

### DESCRIPTION OF THE PREFERRED EMBODIMENTS

The present invention is a manually operated device that dices food items in a single sliding action

The principles and operation of a manually operated device that dices food items according to the present invention may be better understood with reference to the drawings and the accompanying description.

By way of introduction, the manually operated dicer of the present invention is designed such that the single user action of moving the food item carriage, in which a food item has been placed, across the top surface of the frame structure from one end to the other produces diced food items. It should be noted that all of the grammatical variations of the term “dice” are not intended to limit the scope of the present invention in any way and that the principles of the present invention may be used to cut food items into strips as well as cubes, as will be discussed below.

In some embodiments it is necessary to perform a return stroke in which the food item carriage is returned to its original position in order to perform another dicing action. In other embodiments, two slicing blades are deployed in the frame structure and moving the food item carriage in either direction across the top surface of the frame structure from one end to the other produces diced food items and no return stroke is necessary.

The frame structure of the dicer of the present invention is supported above a support surface by legs which may or may not be foldable. The frame structure has a top surface that includes at least a first slicing blade and at least one carriage guide configuration, preferably grooves or slots configured in the side walls of the frame structure.

The food item carriage is displaceably deployed on the frame structure by way of the carriage guide configuration. The food item carriage includes an upper receptacle for receiving food items and a lower dicing blade platform, such that as the food item carriage traverses the length of the frame structure in a cutting direction, the upper receptacle passes over the slicing blade after which the carriage guide configuration brings the top surface of the lower dicing blade platform into contact with the bottom dicing surface of the frame structure.

Therefore, the method used by the present invention to dice the food items includes the steps of:

1. Slicing the food item using a slicing blade deployed relative to the top surface of the frame structure. It should be noted that is some embodiments of the present invention, the initial “slicing” may render the cut food item into a plurality of strips rather than a single slice.

2. Depositing the resulting slice of the food item on the top surface of the dicing blade platform.

3. Bringing the top surface of the dicing blade platform into contact with the dicing surface configured in the bottom surface of the frame structure, thereby forcing the slice through the dicing blade platform.

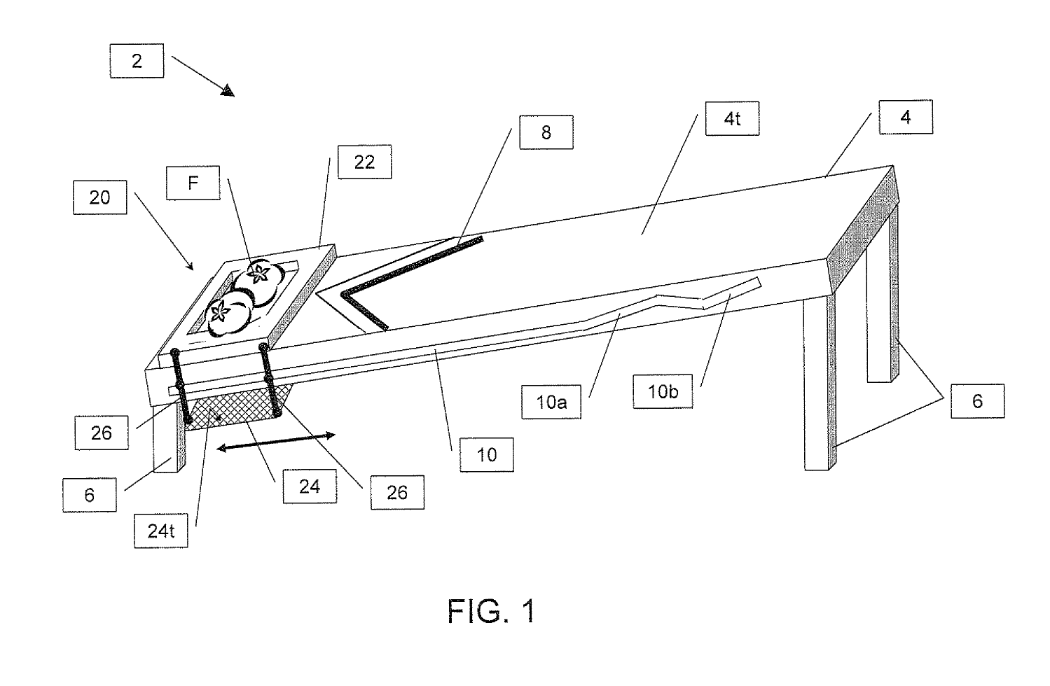

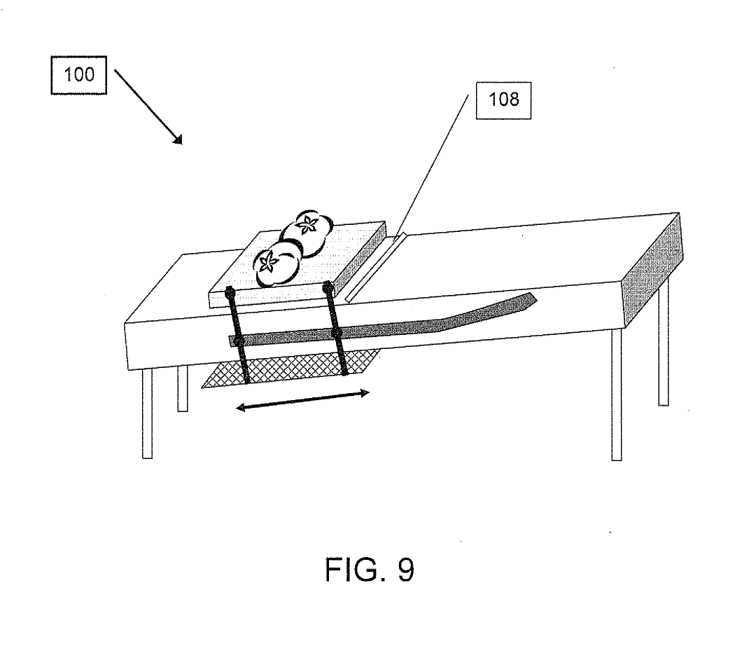

Referring now to the drawings, FIG. 1 illustrates a first preferred embodiment of a manually operated food dicer 2 of the present invention. The food dicer 2 includes a frame structure 4 that is supported above the working surface, such as a table top or kitchen cabinet top, by legs 6. The top surface 4t of the frame structure 4 includes slicing blade 8. It should be noted that while the slicing blade 8 illustrated herein is triangular is shape, this is meant to serve only as a non-limiting example and substantially any suitable blade shape such as, but not limited to, straight (FIG. 9), angled, curved and serrated, is within the scope of the present invention.

The frame structure 2 also includes at least one carriage guide configuration, which in this embodiment is configured as two corresponding longitudinal slots 10 (only one shown) on opposite sides of frame structure 2.

Displaceably deployed on frame structure 2, by way of the carriage guide configuration longitudinal slots 10 is the food item carriage 20. It will be appreciated that slots 10 may alternatively be configured as grooves, or substantially any arrangement that provides displaceable connection between the frame structure 2 and the food item carriage 20.

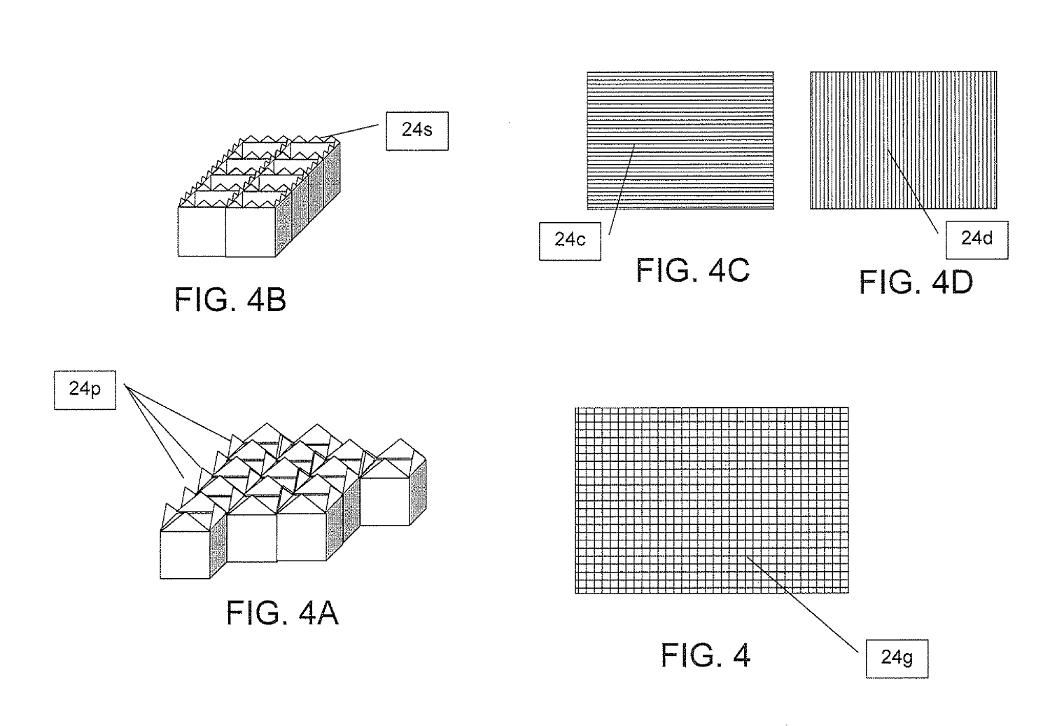

As seen here, the food item carriage 20 includes an upper receptacle 22 for receiving food items F and a lower dicing blade platform 24. The top surface 24t of the lower dicing blade platform is configured with cutting edges as will be discussed below with regard to FIGS. 4-4D. The upper receptacle 22 and the lower dicing blade platform 24 are interconnected by connecting elements 26 which also engage the longitudinal slots 10.

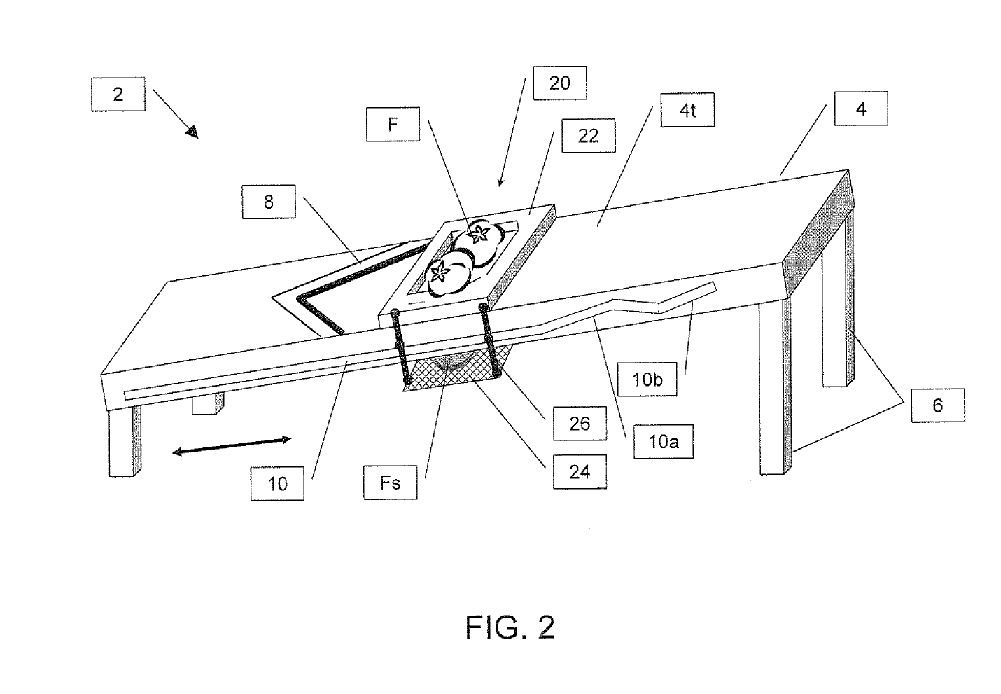

The food item carriage 20 is illustrated here at the beginning of the cutting stroke. As the food item carriage traverses a length of the frame structure in a cutting direction, the upper receptacle passes over the slicing blade as illustrated in FIG. 2 and a slice Fs of the food item F falls onto the top surface 24t of the lower dicing blade platform 24.

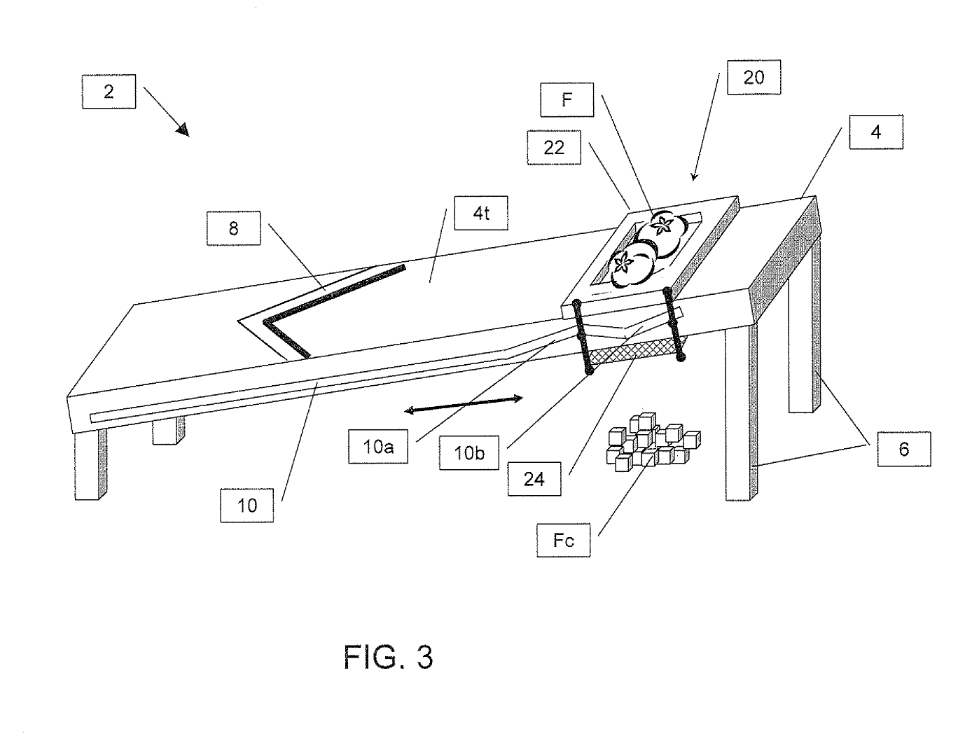

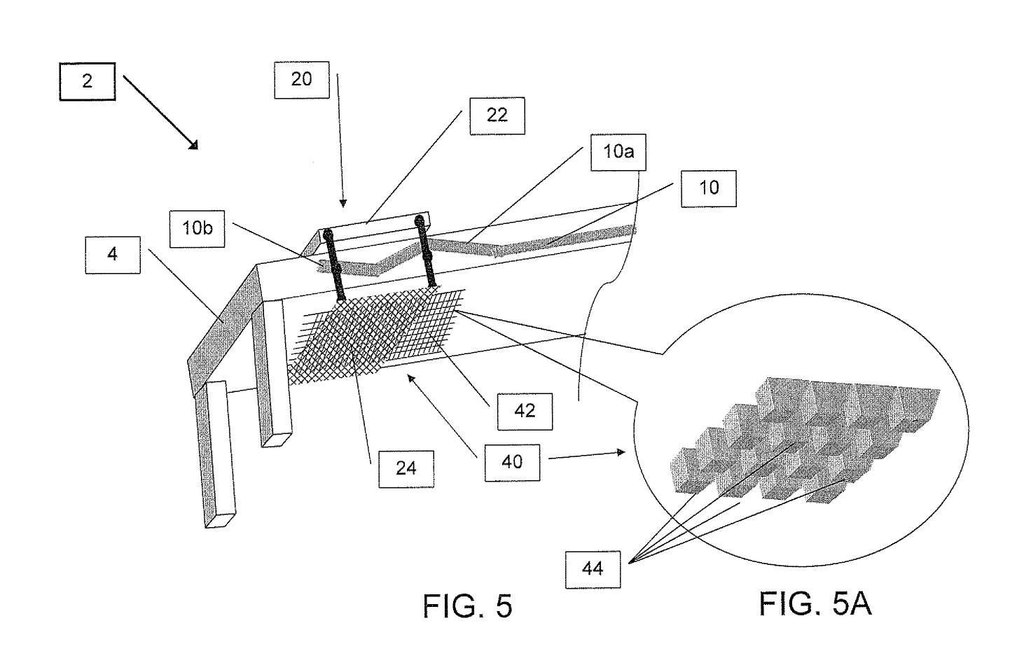

At the end of the cutting stroke, as illustrated in FIG. 3, the upwardly sloped regions 10a and 10b bring the top surface 24t of the lower dicing blade platform 24 into contact with a bottom dicing surface 40 (best seen in FIGS. 5-7B) of the frame structure 4. It will be understood that upwardly sloped regions 10a and 10b illustrated here are substantially parallel so as to maintain a substantially parallel relationship between the top surface 24t of the lower dicing blade platform 24 and the bottom dicing surface 40.

As the top surface 24t of the lower dicing blade platform 24 moves toward bottom dicing surface 40, the cutting edges of the lower dicing blade platform 24 cut through the slice Fs of the food item which produces diced food cubes Fc.

It will be readily understood that in this embodiment of the present invention a return stroke is needed in order to perform the next cutting stroke.

FIGS. 4-4D illustrate various options regarding the lower dicing blade platform 24. FIG. 4 illustrates a grid-like arrangement 24g in which cutting blades are aligned in both longitudinal and lateral directions so as to produce cubed food pieces. It will be appreciated that for some food items such as hard cheese, a substantially straight cutting blade surface is sufficient. However, for some food items such as tomatoes, the cutting blades may be configured with points, as illustrated by blades 24p in FIG. 4A, serrated edges, as illustrated by blades 24s in FIG. 4B, or other skin-piercing edges.

FIGS. 4C and 4D illustrate alternative variations for lower dicing blade platform 24 that produce food items cut into strips. The cutting blades 24c in FIG. 4C are aligned longitudinally and the cutting blades 24d in FIG. 4D are aligned laterally.

FIG. 5 illustrates the bottom dicing surface 40 of the frame structure 4. Optionally, the bottom dicing surface 40 may include a grid of grooves that substantially correspond to the alignment of the cutting blades of the lower dicing blade platform 24. Such an arrangement allows the “raised” areas 44 between the grooves to push the diced food item cubes from between the cutting blades of the lower dicing blade platform 24. This arrangement is of particular benefit when used with serrated cutting blade edges.

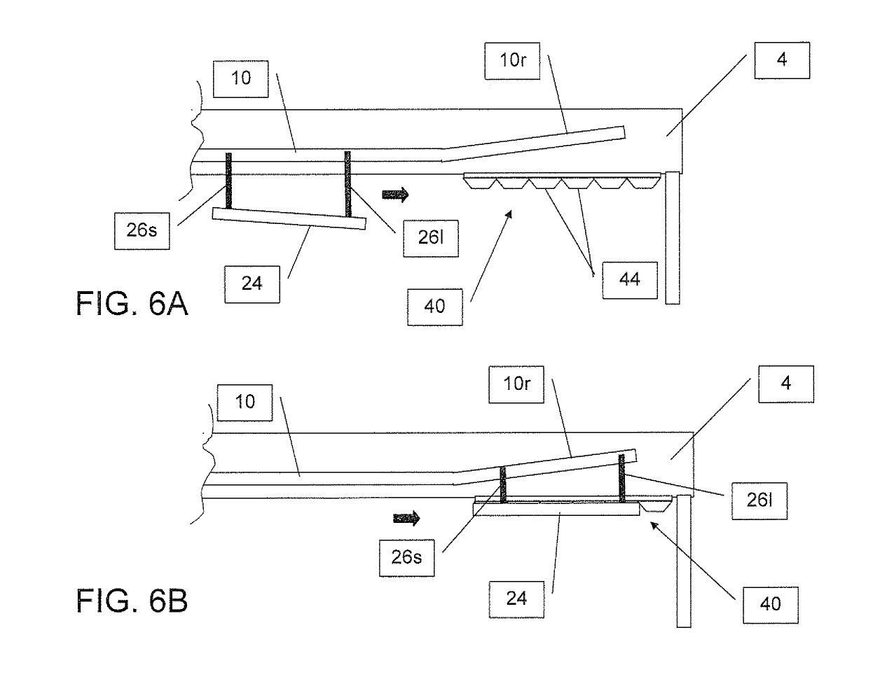

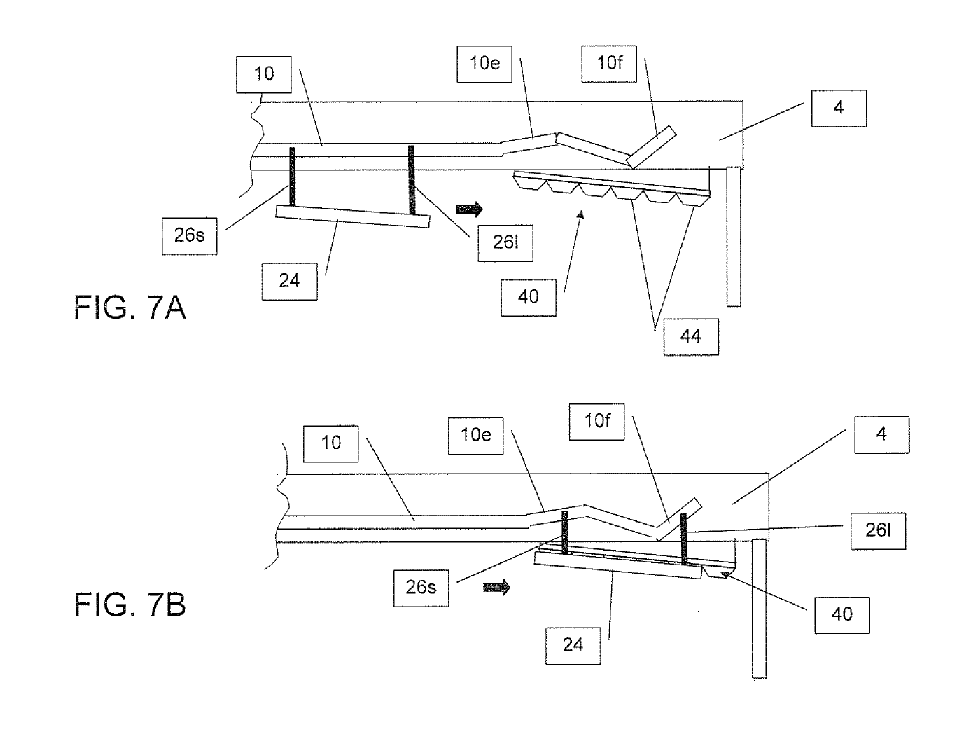

With regard to FIGS. 6A-7B, it will be understood that while the illustrations here show only the lower portion of food item carriage 20 as illustrated in FIGS. 1-3, that is, only the lower dicing blade platform and lower portions of the connecting elements 26, this is for illustrative purposes only and the food item carriage 20 is to be considered as if illustrated here in its entirety. Further, since many of the components of the present invention illustrated in FIGS. 6A-7B are similar to, and perform the same functions as, the components of FIGS. 1-3, the same reference numerals are used here for such similar components.

FIGS. 6A and 6B illustrate an alternative variation of the carriage guide configuration of the present invention, which is also illustrated here as two corresponding longitudinal slots 10 having a single upwardly sloped region 10r. In this embodiment, connecting elements 26s are shorter than connecting elements 261, such that the lower dicing blade platform 24 slopes downward in the direction of the cutting stroke (arrow).

At the end of the cutting stroke, as illustrated in FIG. 6B, the upwardly sloped region 10r brings the top surface of the lower dicing blade platform 24 into contact with a bottom dicing surface 40 of the frame structure 4. It will be understood that since connecting elements 26l traverse further along upwardly sloped region 10r the downward sloping lower dicing blade platform 24 is brought into an alignment that is substantially parallel to the bottom dicing surface 40. Also note how the cutting blades of the lower dicing blade platform 24 engage the grooves of the bottom dicing surface 40 such that the “raised” areas 44 are able to push the diced food item cubes from between the cutting blades of the lower dicing blade platform 24.

Similarly, FIGS. 7A and 7B illustrate an alternative variation of the carriage guide configuration of the present invention, which is also illustrated here as two corresponding longitudinal slots 10 having two upwardly sloped regions 10e and 10f and a downwardly sloping bottom dicing surface 40 of the frame structure 4. Note that upwardly sloped region 10f has a steeper slope than upwardly sloped region 10e. Here too, connecting elements 26s are shorter than connecting elements 261, such that the lower dicing blade platform 24 slopes downward in the direction of the cutting stroke (arrow).

At the end of the cutting stroke, as illustrated in FIG. 7B, the upwardly sloped regions 10e and 10f bring the top surface of the lower dicing blade platform 24 into contact with a bottom dicing surface 40 of the frame structure 4. It will be understood that since connecting elements 26l traverse along upwardly sloped region 10f the downward sloping lower dicing blade platform 24 is brought into an alignment that is substantially parallel to the bottom dicing surface 40. Also note how the cutting blades of the lower dicing blade platform 24 engage the grooves of the bottom dicing surface 40 such that the “raised” areas 44 are able to push the diced food item cubes from between the cutting blades of the lower dicing blade platform 24.

It will be appreciated that the variations illustrated in FIGS. 6A-7B result in a more forceful engagement of the top surface of the lower dicing blade platform 24 with a bottom dicing surface 40.

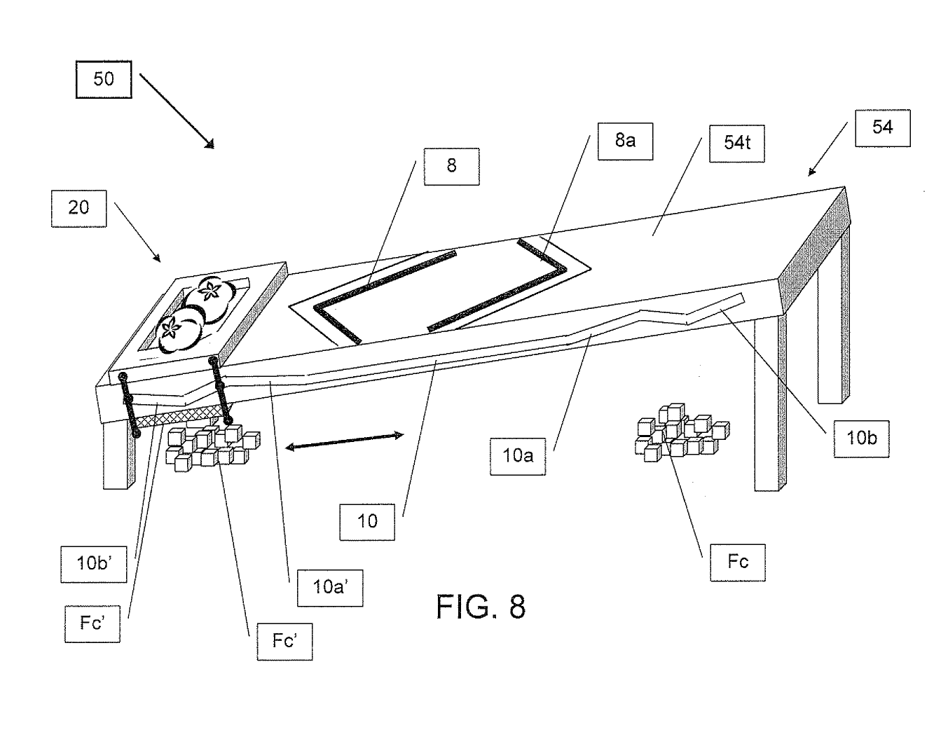

FIG. 8 illustrates a second preferred embodiment of a food dicer 50 of the present invention. The food dicer 50 includes a frame structure 54. The top surface 54t of the frame structure 54 includes two slicing blades 8 and 8a with cutting edge facing in opposite directions.

The two corresponding longitudinal slots 10 (only one shown) on opposite sides of frame structure 54 include upwardly sloped regions 10a and 10b and 10a′ and 10b′ configured in both end regions of the longitudinal slots 10.

It will be understood that the operation of the food dicer 50 of this embodiment is substantially the same as described about, with displacement the food item carriage 20 in either direction constituting a cutting stroke and resulting in diced food item cubes Fc and Fc′ being deposited at each end of the frame structure 54. That is to say, the cutting stroke is performed during a single pass in a first direction and then repeated in a second direction.

FIG. 9 illustrates a food dicer 100 of the present invention that includes a straight slicing blade 108.

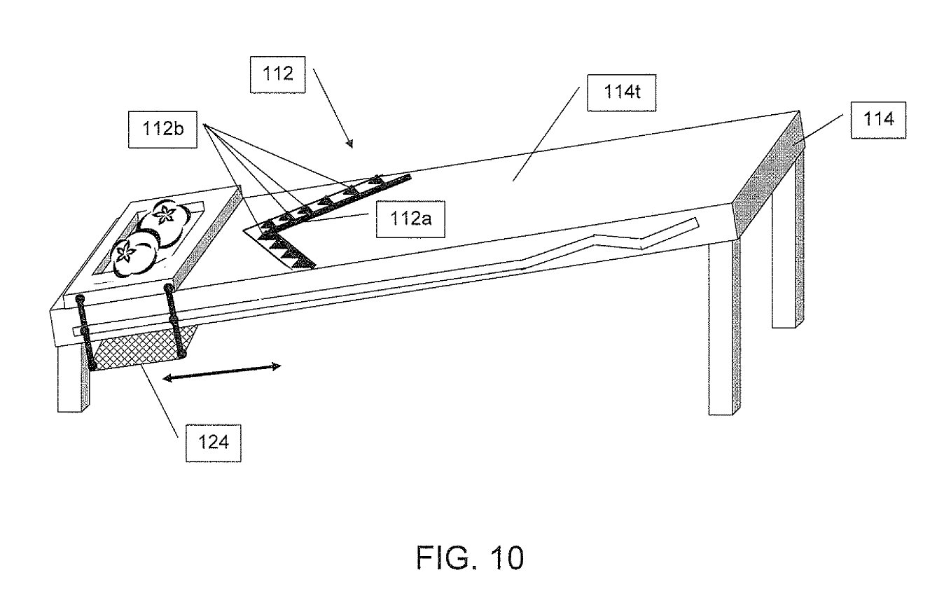

FIG. 10 illustrates a food dicer 110 of the present invention that is configured with a variant of the slicing blade. The slicing blade arrangement 112 illustrated here includes a slicing blade 112a, whose cutting edge is parallel to the plane of the top surface 114t of the frame structure 114, and a plurality of strip cutting blades 112b that are deployed parallel to one another in front of the slicing blade 112a. The cutting edges of the strip cutting blades 112b are perpendicular to the plane of the top surface 114t. With this slicing blade arrangement, the final cut to produce diced food items may be affected using a lower dicing blade platform 124 that has cutting blades that are aligned laterally such as cutting blades 24d in FIG. 4D.

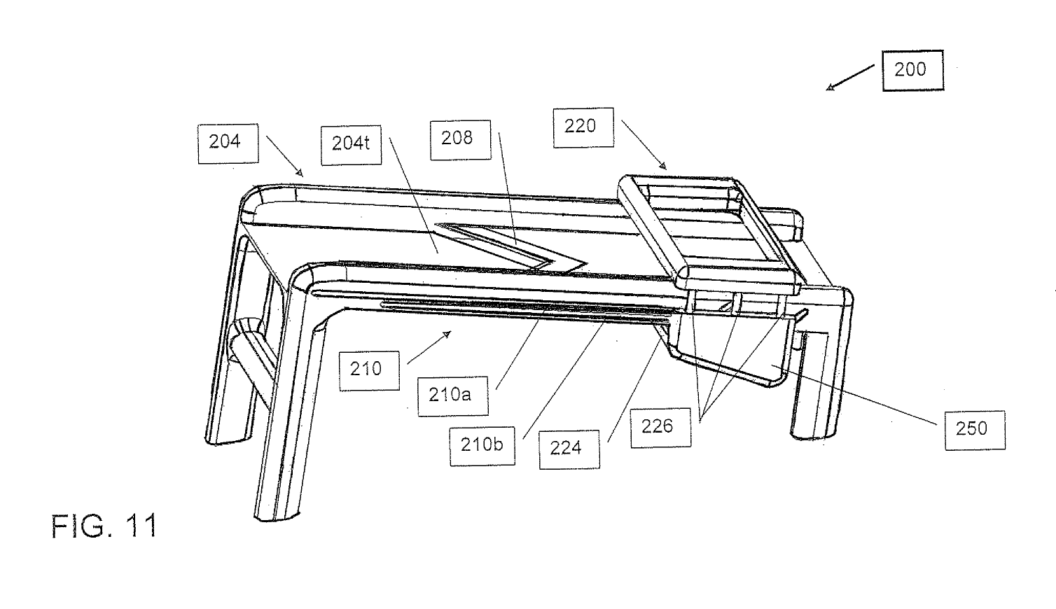

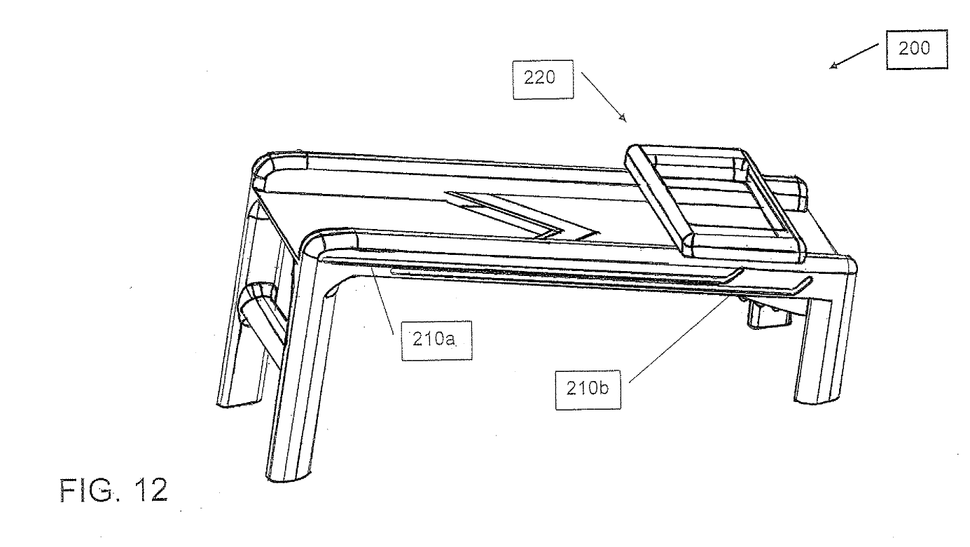

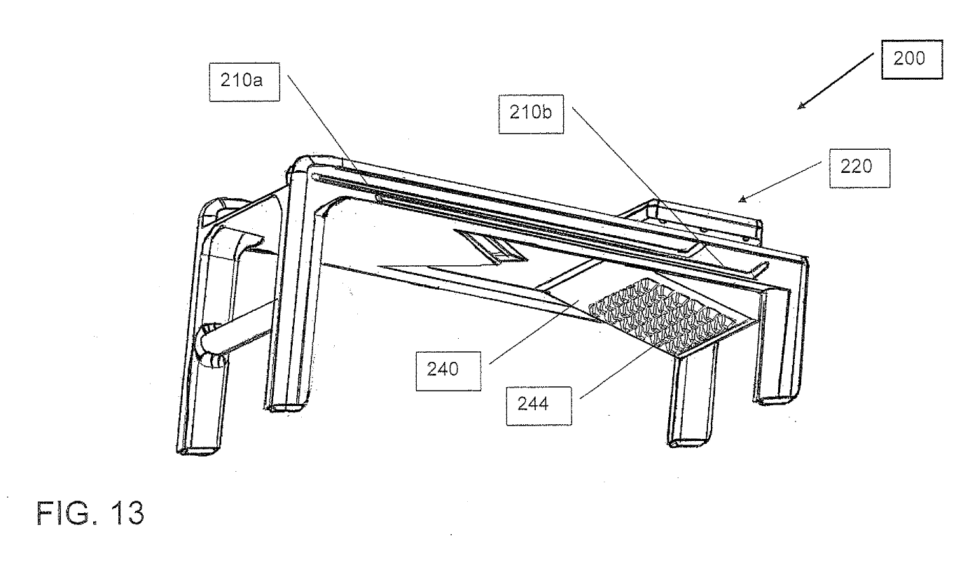

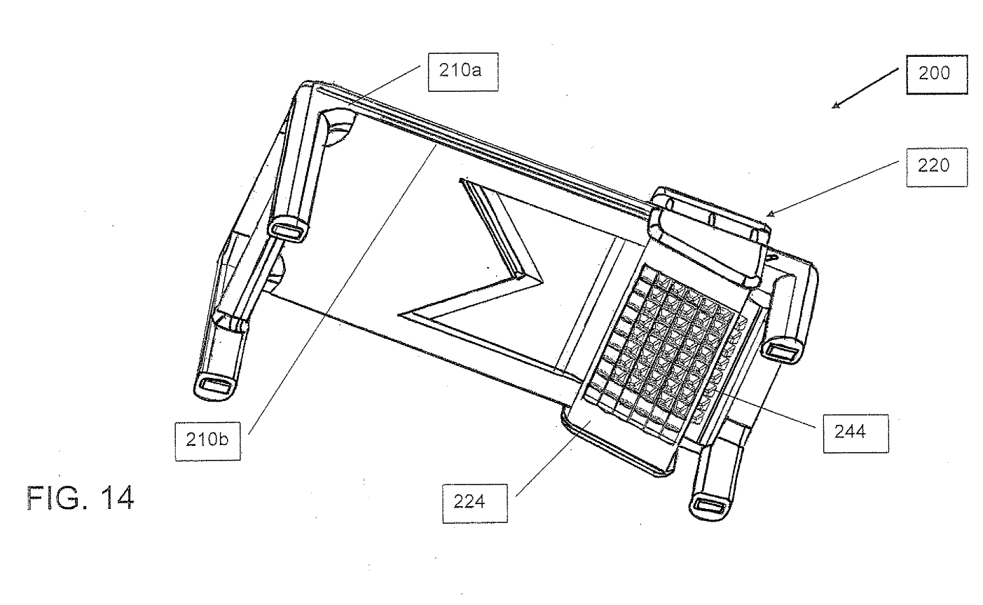

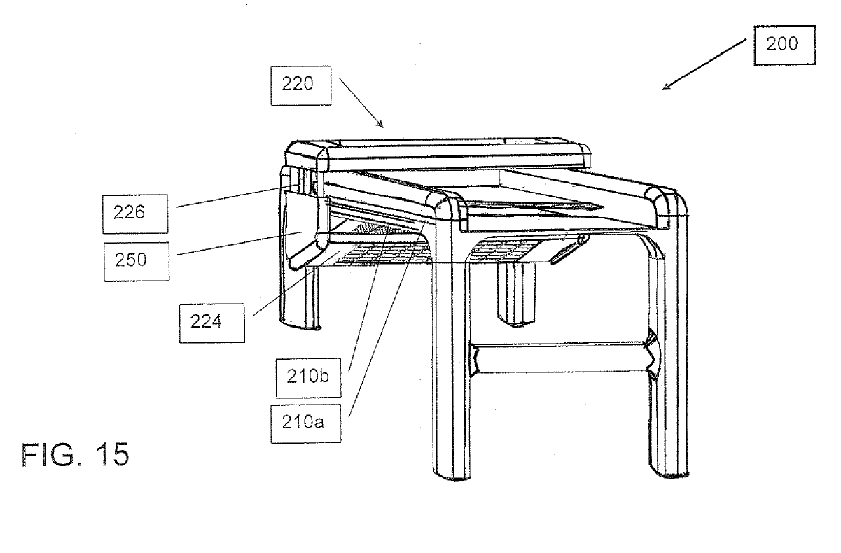

FIGS. 11-15 illustrate a third preferred embodiment 200 of the manual food dicer of the present invention. The food dicer 200 includes a frame structure 204. The top surface 204t of the frame structure 204 includes slicing blade 208.

This embodiment is configured with four corresponding longitudinal slots 210 (only two shown 10a and 10b) with two slots configured on each of the opposite sides of frame structure 204. Each of the longitudinal slots 210 include upwardly sloping regions at the end of the longitudinal slots 210 that correspond to the end of the cutting stoke. Side elements 250 include two slot engagement components (not show) each of which engages a different one of the two longitudinal slots 210.

It will be understood that the operation of the food dicer 200 of this embodiment is substantially the same as described about, with displacement the food item carriage 220 in a direction constituting a cutting stroke sliced food pieces deposited on the top surface of the lower dicing blade platform 224.

At the end of the cutting stroke, the upwardly sloping regions bring the top surface of the lower dicing blade platform 224 into contact with a bottom dicing surface 240 of the frame structure 204 such that the cutting blades of the lower dicing blade platform 224 engage the grooves of the bottom dicing surface 240 such that the “raised” areas 244 are able to push the diced food item cubes from between the cutting blades of the lower dicing blade platform 224.

It will be appreciated that the above descriptions are intended only to serve as examples and that many other embodiments are possible within the spirit and the scope of the present invention.

What is claimed is:

1. A manually operated food dicer comprising:
(a) a frame structure which is supported above a support surface, said frame structure having a top surface that includes at least a first slicing blade said frame structure including at least one carriage guide configuration;
(b) a food item carriage displaceably deployed on said frame structure by way of said carriage guide configuration, said food item carriage including an upper receptacle for receiving food items and a lower dicing blade platform;
wherein as said food item carriage traverses a length of said frame structure in a cutting direction, said upper receptacle passes over said slicing blade, after which said carriage guide configuration brings a top surface of said lower dicing blade platform into contact with a bottom dicing surface of said frame structure.

2. The manually operated food dicer of claim 1, wherein said carriage guide configuration includes corresponding longitudinal slots configured on opposite longitudinal sides of said frame structure and said food item carriage is configured to engage said corresponding longitudinal slots.

3. The manually operated food dicer of claim 2, wherein said corresponding longitudinal slots are configured as four corresponding longitudinal slots with two said longitudinal slots configured on each of the opposite sides of said frame structure.

4. The manually operated food dicer of claim 2, wherein said corresponding longitudinal slots are configured to guide said dicing blade platform into said contact with said bottom dicing surface of said frame structure.

5. The manually operated food dicer of claim 2, wherein said engagement of said food item carriage with said corresponding longitudinal slots includes engagement of at least one connecting element by which said upper receptacle and said lower dicing blade platform are connected.

6. The manually operated food dicer of claim 1, wherein said dicing blade platform includes blades arranged in a grid configuration.

7. The manually operated food dicer of claim 6, wherein bottom dicing surface of said frame structure includes grooves arranged in a grid configuration corresponding to said grid configuration of said dicing blade platform.

8. The manually operated food dicer of claim 7, wherein bottom dicing surface of said frame structure includes raised areas between said grooves so as to push food item cubes from said dicing blade platform.

9. The manually operated food dicer of claim 1, further including strip cutting blades associated with said slicing blade.

10. The manually operated food dicer of claim 9, wherein said dicing blade platform includes blades arranged perpendicular to a length of said frame structure.

11. A method for dicing food items, the method comprising:
(a) cutting the food item using at least a slicing blade deployed relative to a top surface of a frame structure;
(b) depositing resulting cut food item on a top surface of a dicing blade platform;
(c) bring said top surface of said dicing blade platform into contact with a dicing surface configured in a bottom surface of said frame structure, thereby forcing said cut food item through said dicing blade platform.

12. The method of claim 11, wherein steps a, b and c are performed during a single pass as said food item carriage traverses a length of said frame structure in a cutting direction.

13. The method of claim 11, wherein steps a, b and c are performed during a single pass as said food item carriage traverses a length of said frame structure in a first direction and then repeated as said food item carriage traverses a length of said frame structure in a second direction.

14. The method of claim 11, wherein said forcing said cut food item through said dicing blade platform is implemented using raised areas provided in said dicing surface.
